(19) United States
(12) Patent Application Publication
(10) Pub. No.: US 2010/0094761 A1
(43) Pub. Date: Apr. 15, 2010

(54) Method for User Driven Product Design and Marketing

(76) Inventor: Cy Khormaee, (US)

Correspondence Address: Cy Khormaee, 4720 Rosedale Ave., Apartment #320, Bethesda, MD, 20814, US

(21) Appl. No.: 12/249,939

(22) Filed: Oct. 12, 2008

(51) Int. Cl. G06Q 99/00

(52) U.S. Cl. 705/300

(57) ABSTRACT

A Method of User Driven Product Design and Marketing includes the steps of user design submissions, selection submissions for product development, and trailing product marketing. The design may comprise any representation of a product or even the product itself in the case of visual and graphic design. Users will be given the opportunity to submit design proposals. One or more of these designs may be chosen for further development by overall popularity or an entity with the means and intent to license and produce the design. Once the design is incarnated as a finished product, the initial product marketed will be focused on developing a core affiliate program from the participants in the initial submission of designs.

### BACKGROUND

Conventional practice in the product design and marketing consists of specialists making all of the initial designs. Then, the specialists may proceed to validate their designs by working with focus groups and surveys of the real users. However, this method limits the scope of possible designs to the imagination of the specialists assigned to a given design or marketing task. Furthermore, the specialists' validation practice rarely is able to encompass any significant portion of their total audience.

An additional hurtle in the product marketing space is the general public has actively begun to ignore advertising. Generations born after the advent of television have been raised to ignore and distrust any overt marketing the encounter. Conventional broadcast (one to many) techniques are failing and this necessitates a new way to reach a broad audience of consumers.

### SPECIFICATION

The present invention provides a method for enabling a large number of arbitrary users to collaborate to produce and market their own products. The three acting parties in this case are entities who submit designs (authors), people who view/rate designs (users), entities who develop/distribute products professionally (producers), and the company implementing this Method of User Driven Product Design and Marketing (the intermediary). None of these terms are exclusive—any entity may play any combination of roles (exemplified by the fact that a author can also be a user).

The core design method begins with some arbitrary entity proposing a need or theme (the proposal) 101. This will guide, but not govern the user design method (authors are not restricted by this). Then, users will begin submitting a set of design proposals 102. The entity initiating the proposal as well as some set of other entities will be receiving design proposals 103. The term design proposals may also include submission of an actual product for non-tangible good (visual art/logos/rhetoric). One or more designs can be identified for production either by audience popularity 104 or by a producer selecting a design they want to produce 105. Popularity is calculated by an equation including, but not limited to some combination of user activity around the design (s) (clicks/views/links), author track record (has this author produced successful work in the past?) and user voting (rating, preordering).

Once the design or designs are identified for production, some parties will be assigned by either the intermediary or producer to produce the product 106. Note that an intermediary or producer may assign themselves or each other. Producing the product typically includes, but is not limited to refinement of the design, manufacture of the resulting product (the product), and sales/distribution of the product 107. Refinement of the design this may include, but is not limited to any type of alteration, combination, or transfer of designs to a new media (s). Manufacture of the resulting product also includes the transfer/incarnation of the design in a new form (exemplified by a 3D model design being created with a plastic mold). Authors will be rewarded for if their design is selected for production 109 & 110.

One the product is ready to sell (or license), any of the involved entities may market the product. However, the focus of the market entry effort will be around developing a user driven marketing program. The intermediary or producers will be a concerted effort to attract affiliates from the pool of system users—especially the author of the selected design or those authors submitting relevant competing designs 109. Users/authors who will receive a sales commission are known as affiliates 112 & 113. The premise for this focus is that users will be more likely to connect with the author of the product, as they are more relevant to the user than corporate branded marketing or a sales specialist.

Breadth marketing and advertising of this project will be targeted at entities identified as similar to the authors of the project 108. The similarities can be identified by selecting some set of relevant characteristics, and finding entities who share those characteristics with a project author. In addition to breadth marketing (display/contextual ads), identification of the similarities between an author and potential consumer can be leveraged to target the efforts of an author who is a member of the affiliate program 111.

Overall, enabling users to work to drive the design and marketing process in the product development lifecycle will increase the breadth and quality of designs as well as providing a more relevant and compelling marketing team (the affiliates).

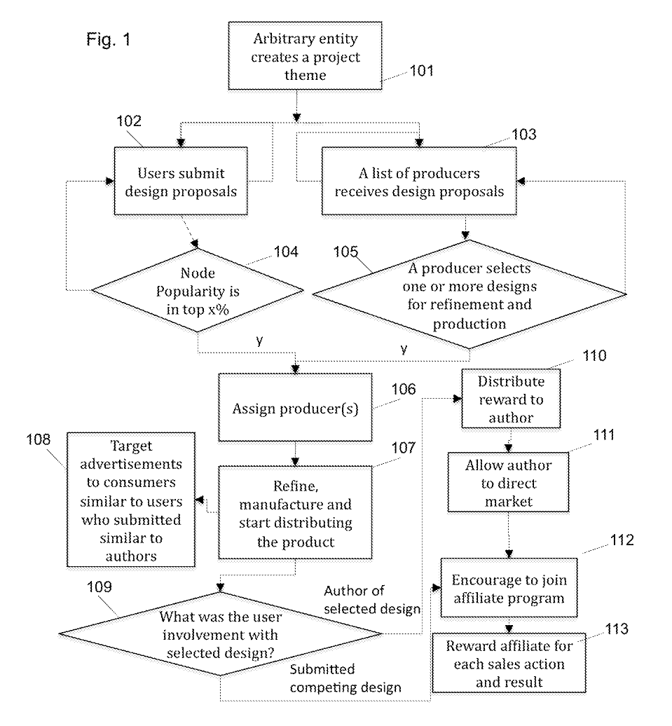

FIG. 1 shows a block diagram of components of a system for user driven product design and development.

1. A method of product development using ad-hoc user groups, said method comprising:
selecting a product theme as a request for proposals to a plurality of individuals
enabling said individuals to edit some, all, or none of said submissions and submit the resulting product as a new product submission
selecting one or more said product submission for further development
marketing said product submission selected for further development

2. The method of claim 1, said product theme to include any manner of design or development project including 2 and 3 dimensional visual design, graphical representations of physical structures, process schematics, software architecture, and industrial design concepts.

3. The method of claim 1, said selecting of a product theme to be conducted in any manner by some plurality of individuals including an unrelated third party, authors of said request for proposals, and the plurality of individuals responding to the request for proposals.

4. The method of claim 1, said request for proposals to include any manner of communication to define the scope of desired user responses including images, written descriptions, individual words, and audio. Said request for proposals also need not be restricted to any static definition. Said request for proposals may be altered at any time either by predetermined method, random process, or intervention by any plurality of individuals.

5. The method of claim 1, said enabling said individuals to edit refers to providing said users with the means to some means to acquire copies, representations, or some version of said product submission and alter it from it's original form to subsequently submit the altered product submission as a related product submission.

6. The method of claim 5, said related product submission referring to any product submission resulting from the editing of an existing submission by said individuals.

7. The method of claim 5, said edit may utilize one or more existing submissions.

8. The method of claim 1, said recording of product submissions including the creation of a recording indicating the time, date, name, location of storage, author or related product submission of said submissions.

9. The method of claim 13, said originating submission referring to any of the initial product submissions edited by the same or a secondary user to create a new submission.

10. The method of claim 1, said selecting one or more said product submissions for further development includes any manner of alteration and refinement by the original authors, a third party, or any plurality of individuals.

11. The method of claim 1, said submission authors including any individual any of the plurality of users involved in the submission or involved the creation of a submission modified to result in the selected submission.
